(19) United States
(12) Patent Application Publication
(10) Pub. No.: US 2025/0353331 A1
(43) Pub. Date: Nov. 20, 2025

(54) TIRE

(71) Applicant: HANKOOK TIRE & TECHNOLOGY CO., LTD., Gyeonggi-do (KR)

(72) Inventors: Minhyun CHOI, Daejeon (KR); Kwangsu LEE, Daejeon (KR); Haemi SONG, Daejeon (KR); Woosung AHN, Daejeon (KR)

(73) Assignee: HANKOOK TIRE & TECHNOLOGY CO., LTD., Gyeonggi-do (KR)

(21) Appl. No.: 19/208,517

(22) Filed: May 14, 2025

(30) Foreign Application Priority Data
May 14, 2024 (KR) 10-2024-0062968

(51) Int. Cl. B60C 13/00

(52) U.S. Cl. CPC B60C 13/001

(57) ABSTRACT

A tire comprising a sidewall including a display portion on a surface thereof where characters or graphics are displayed, and a non-display portion on the surface excluding the display portion, wherein the display portion comprises a base portion recessed with respect to the non-display portion, and a projection portion provided in a closed-loop shape on the base portion.

### CROSS-REFERENCE TO RELATED APPLICATION(S)

This application is based on and claims priority under 35 U.S.C. § 119 to Korean Patent Application No. 10-2024-0062968, filed on May 14, 2024, in the Korean Intellectual Property Office, the disclosure of which is incorporated by reference herein in its entirety.

### BACKGROUND

### 1. Field

The disclosure relates to a tire, and more particularly, to a tire with an improved structure of a sidewall.

### 2. Description of the Related Art

A tire may include a wheel and a tread surrounding the wheel and contacting the ground, and a sidewall may be provided between the wheel and the tread.

The sidewall is located on the lateral surface of the tire and may serve to protect the tire from lateral impacts.

In particular, characters or graphics may be displayed on the surface of the sidewall. For example, the characters or graphics may represent the logo of the tire manufacturer or the product number of the tire. Furthermore, the characters or graphics may form a QR code.

To enhance the visibility of such characters or graphics, colors such as white have been applied, or fine grooves or irregularities have been provided to create visual contrast when viewed with the naked eye.

### SUMMARY

According to an embodiment, the tire may comprise a sidewall. The sidewall may include a display portion on a surface thereof where characters or graphics are displayed, and a non-display portion on the surface excluding the display portion. The display portion may comprise a base portion and a projection portion. The base portion may be recessed with respect to the non-display portion. Accordingly, a tire is provided in which the durability of the sidewall is secured, and contamination of the display portion is prevented.

The projection portion may be provided in a closed-loop shape on the base portion. Accordingly, a tire is provided in which the contrast of the display portion is enhanced, thereby improving the visibility of the display portion.

According to one aspect of the disclosure, a tire comprises a sidewall including a display portion on a surface thereof where characters or graphics are displayed, and a non-display portion on the surface excluding the display portion. The display portion may comprise a base portion recessed with respect to the non-display portion, and a projection portion provided in a closed-loop shape on the base portion.

The projection portion may be recessed with respect to the non-display portion.

A plurality of projection portions may be provided, and the plurality of projection portions may be configured to be congruent with each other.

The plurality of projection portions may be alternately arranged with different phase differences.

Two adjacent projection portions may have a phase difference of 90°.

Each of the projection portions may comprise a pair of protrusions formed to protrude outward and a pair of recesses formed to be indented inward.

One of the pair of protrusions provided on one projection portion may be insertable into one of the pair of recesses provided on an adjacent projection portion.

Each of the pair of protrusions may have an obtuse angle facing each other, and each of the pair of recesses may have a reentrant angle facing each other.

A sum of the obtuse angle and the reentrant angle may be 360°.

The projection portion may further comprise four right-angle portions connecting the pair of protrusions and the pair of recesses at right angles.

The base portion may be provided as a pair for each projection portion, disposed on both sides toward the pair of protrusions, and each may be concave with respect to the projection portion.

The plurality of projection portions may be arranged inclined in both a radial direction and a circumferential direction.

According to an embodiment, the tire may comprise a sidewall. The sidewall may include a display portion on a surface thereof where characters or graphics are displayed, and a non-display portion on the surface excluding the display portion. The display portion may comprise a base portion and a projection portion. The base portion may be recessed with respect to the non-display portion. Accordingly, the tire provides an effect in which the durability of the sidewall is secured, and contamination of the display portion is prevented.

In addition, the projection portion may be provided in a closed-loop shape on the base portion. Accordingly, the tire provides an effect in which the contrast of the display portion is enhanced, thereby improving the visibility of the display portion.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an embodiment of a tire according to an embodiment of the disclosure.

FIG. 2 is a plan view illustrating an embodiment of a portion of the sidewall included in the tire of FIG. 1.

FIG. 3 is an enlarged view illustrating an embodiment of a display portion included in the sidewall of FIG. 2.

FIG. 4 is a cross-sectional view illustrating an embodiment of the display portion of FIG. 3.

FIG. 5 is a perspective view illustrating another embodiment of a tire according to another embodiment of the disclosure.

FIG. 6 is a plan view illustrating an embodiment of a portion of the sidewall included in the tire of FIG. 5.

FIG. 7 is an enlarged view illustrating an embodiment of a display portion included in the sidewall of FIG. 6.

### DETAILED DESCRIPTION OF EMBODIMENTS

Hereinafter, embodiments of the disclosure will be described in detail with reference to the accompanying drawings. The following embodiments are provided to sufficiently transfer the concepts of the present disclosure to one of ordinary skill in the technical art to which the disclosure belongs. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

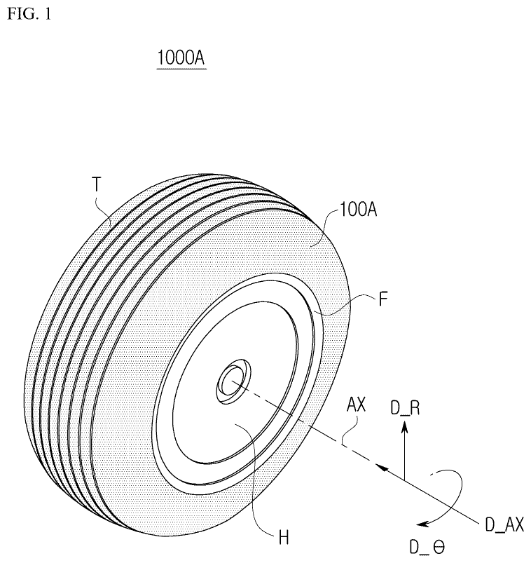

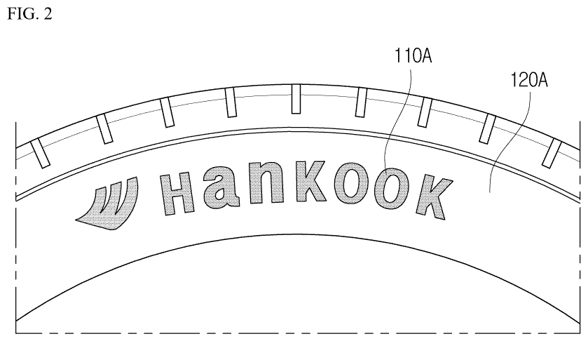

FIG. 1 is a perspective view illustrating an embodiment of a tire according to an embodiment of the disclosure, and FIG. 2 is a plan view illustrating an embodiment of a portion of the sidewall included in the tire of FIG. 1.

Referring to FIGS. 1 and 2, a tire 1000A according to an embodiment may comprise a sidewall 100A.

For example, the tire 1000A may include a wheel H and a tread T that surrounds the wheel H and contacts the ground, and the sidewall 100A may be provided between the wheel H and the tread T. The sidewall 100A is located on a side surface of the tire 1000A and is configured to protect the tire 1000A from lateral impacts. The sidewall 100A may be designed in various shapes and materials to improve the durability and flexibility of the tire 1000A.

Meanwhile, reference symbol “F” in FIG. 1 denotes a flange of the wheel H.

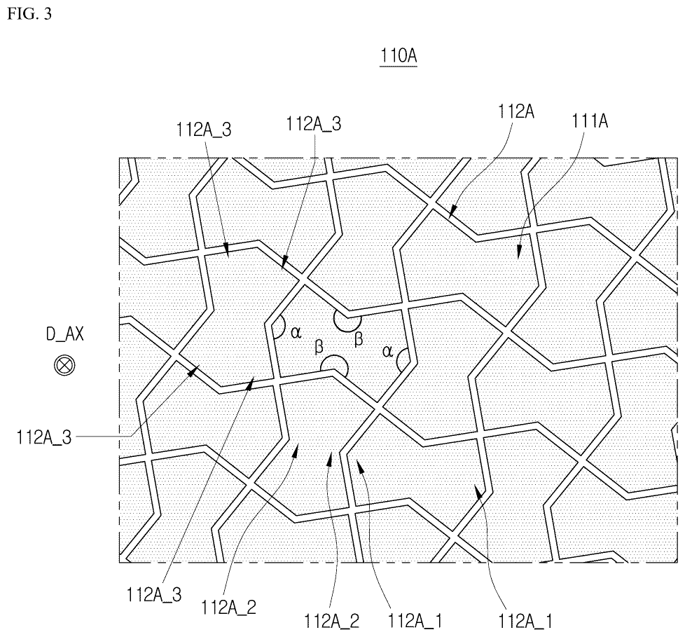

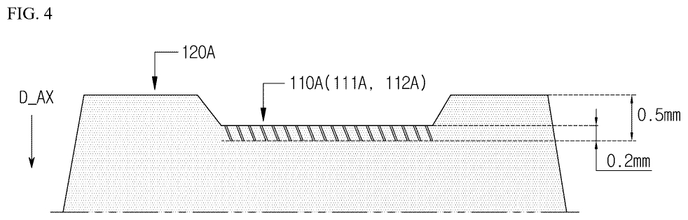

FIG. 3 is an enlarged view illustrating an embodiment of a display portion included in the sidewall of FIG. 2, and FIG. 4 is a cross-sectional view illustrating an embodiment of the display portion of FIG. 3.

Referring to FIGS. 1 to 4, the sidewall 100A may include a display portion 110A on surfaces where characters or graphics are displayed, and a non-display portion 120A on the surfaces excluding the display portion 110A.

The display portion 110A may comprise a base portion 111A and a projection portion 112A.

The base portion 111A may be recessed with respect to the non-display portion 120A. For example, the base portion 111A may be recessed along an axial direction D_AX parallel to a rotation axis AX shown in FIG. 1.

The projection portion 112A may be provided in a closed-loop shape on the base portion 111A. For example, the projection portion 112A may be provided in a closed-loop shape such as polygonal, circular, semicircular, or elliptical on the base portion 111A. In this case, the projection portion 112A may also be recessed with respect to the non-display portion 120A.

In one embodiment, as illustrated in FIG. 3, the closed-loop shape may be an octagon.

In one embodiment, a plurality of projection portions 112A may be provided, and the closed-loop shapes of the respective projection portions may be various combinations of polygons, circles, semicircles, and ellipses.

As described above, the base portion 111A may be recessed with respect to the non-display portion 120A. For example, the base portion 111A may be recessed by 0.5 mm or more with respect to the non-display portion 120A. Accordingly, the durability of the sidewall 100A may be secured and contamination of the display portion 110A may be prevented.

As described above, the projection portion 112A may be provided in a closed-loop shape on the base portion 111A. That is, the base portion 111A may be partitioned by the projection portion 112A. Accordingly, the contrast of the display portion 110A may be enhanced, thereby improving visibility of the display portion 110A.

In one embodiment, the area surrounded by the closed-loop shape of each projection portion 112A on the base portion 111A may be equal to or less than 0.25 mm². Accordingly, the contrast of the display portion 110A may be enhanced, thereby improving its visibility.

In one embodiment, as shown in FIG. 4, the projection portion 112A may be recessed with respect to the non-display portion 120A. For example, the projection portion 112A may be recessed by 0.2 mm or more and 0.5 mm or less with respect to the non-display portion 120A. Accordingly, the durability of the sidewall 100A may be secured and contamination of the display portion 110A may be prevented.

A plurality of projection portions 112A may be provided, and the plurality of projection portions 112A may be configured to be congruent with each other. Accordingly, the projection portions 112A may form a repeating pattern, thereby improving the visibility of the display portion 110A.

The plurality of projection portions 112A may be alternately arranged with different phase differences. For example, the plurality of projection portions 112A may be alternately arranged with different phase differences in a radial direction D_R. For example, the plurality of projection portions 112A may also be arranged with phase differences in a circumferential direction D_θ. Accordingly, the aesthetics of the display portion 110A may be diversified.

In one embodiment, two adjacent projection portions 112A may have a phase difference of 90°. In this case, regularity in the display portion 110A is emphasized, and the visibility thereof may be improved.

Furthermore, the plurality of projection portions 112A may be arranged inclined in both a radial direction D_R and a circumferential direction D_θ. Even in this case, they may be alternately arranged with different phase differences. Accordingly, the display portion 110A may achieve design flexibility and aesthetic variation.

Each of the projection portions 112A may comprise a pair of protrusions 112A_1 formed to protrude outward and a pair of recesses 112A_2 formed to be indented inward. Here, the “outward” and “inward” directions may refer to directions perpendicular to the axial direction D_AX or corresponding directions.

One of the pair of protrusions 112A_1 provided on one of the projection portions 112A may be configured to be insertable into one of the pair of recesses 112A_2 provided on an adjacent projection portion 112A. Accordingly, the base portion 111A and the projection portion 112A can densely and regularly fill the display portion 110A, improving its visibility.

Specifically, as illustrated in FIG. 3, each of the pair of protrusions 112A_1 may have an obtuse angle α facing each other, and each of the pair of recesses 112A_2 may have a reentrant angle β facing each other. In this case, two adjacent projection portions 112A may have a phase difference of 90°, which facilitates regular filling of the display portion 110A. Accordingly, the regularity of the display portion 110A is enhanced, and its visibility is improved.

Here, the reentrant angle β may refer to an angle greater than a straight angle (180°).

In particular, a sum of the obtuse angle α of the pair of protrusions 112A_1 and the reentrant angle β of the pair of recesses 112A_2 may be 360°. In this case, one of the pair of protrusions 112A_1 on one projection portion may easily fit into one of the pair of recesses 112A_2 on the adjacent projection portion. Accordingly, the base portion 111A and the projection portion 112A can densely and regularly fill the display portion 110A, improving its visibility.

Furthermore, the projection portion 112A may further comprise four right-angle portions 112A_3 that connect the pair of protrusions 112A_1 and the pair of recesses 112A_2 at right angles. Accordingly, the right-angle portions 112A_3 also help densely and regularly fill the display portion 110A, enhancing its visibility.

Meanwhile, as illustrated in FIG. 4, the base portion 111A may be provided as a pair for each projection portion 112A, disposed on both sides of the projection portion 112A, and may be concave with respect to the projection portion 112A. Due to the three-dimensional characteristics of the display portion 110A, the visibility thereof is improved.

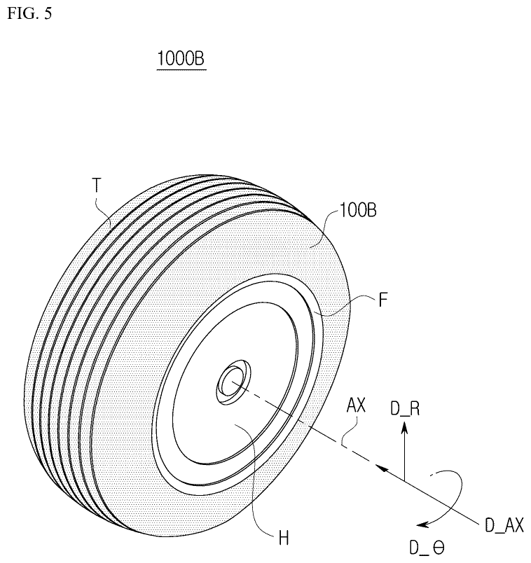

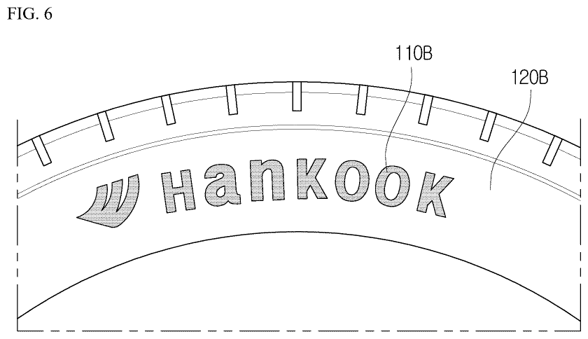

FIG. 5 is a perspective view illustrating another embodiment of a tire according to another embodiment of the disclosure, and FIG. 6 is a plan view illustrating an embodiment of a portion of the sidewall included in the tire of FIG. 5.

Referring to FIGS. 5 and 6, a tire 1000B according to another embodiment may comprise a sidewall 100B.

For example, the tire 1000B may include a wheel H and a tread T that surrounds the wheel H and contacts the ground, and the sidewall 100B may be provided between the wheel H and the tread T. The sidewall 100B is located on a side surface of the tire 1000B and is configured to protect the tire 1000B from lateral impacts. The sidewall 100B may be designed in various shapes and materials to improve the durability and flexibility of the tire 1000B.

Meanwhile, reference symbol “F” in FIG. 5 denotes a flange of the wheel H.

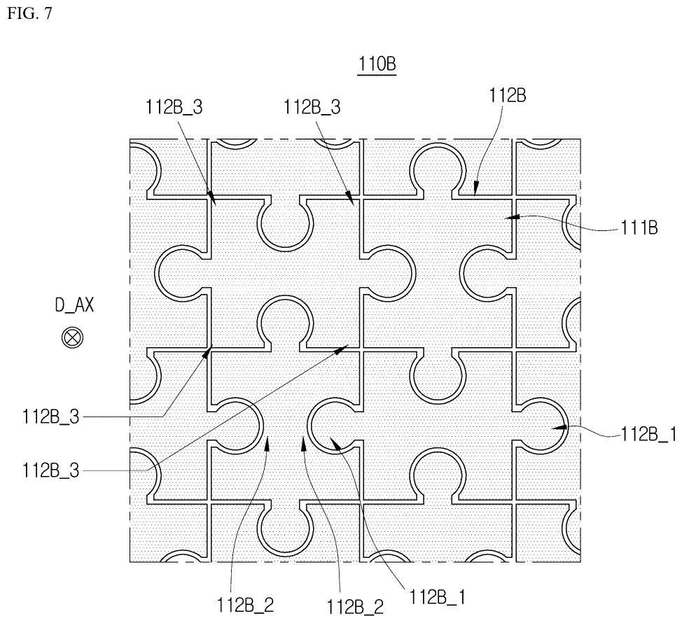

FIG. 7 is an enlarged view illustrating an embodiment of a display portion included in the sidewall of FIG. 6.

Referring to FIGS. 5 to 7, the sidewall 100B may include a display portion 110B on surfaces 110B and 120B where characters or graphics are displayed, and a non-display portion 120B on the surfaces excluding the display portion 110B.

The display portion 110B may comprise a base portion 111B and a projection portion 112B.

The base portion 111B may be recessed with respect to the non-display portion 120B. For example, the base portion 111B may be recessed along an axial direction D_AX parallel to a rotation axis AX shown in FIG. 5.

The projection portion 112B may be provided in a closed-loop shape on the base portion 111B. For example, the projection portion 112B may be in a closed-loop shape such as polygonal, circular, semicircular, or elliptical. In this case, the projection portion 112A may also be recessed with respect to the non-display portion 120A.

In particular, FIG. 7 illustrates a case where the projection portion 112B has a closed-loop shape different from that of projection portion 112A described with reference to FIG. 3.

In one embodiment, as shown in FIG. 7, the closed-loop shape may be a puzzle shape.

As described above, the base portion 111B may be recessed with respect to the non-display portion 120B. For example, the base portion 111B may be recessed by 0.5 mm or more. Accordingly, the durability of the sidewall 100B may be secured and contamination of the display portion 110B may be prevented.

As described above, the projection portion 112B may be provided in a closed-loop shape on the base portion 111B. That is, the base portion 111B may be partitioned by the projection portion 112B. Accordingly, the contrast of the display portion 110B may be enhanced, thereby improving visibility of the display portion 110B.

In one embodiment, the area surrounded by the closed-loop shape of each projection portion 112B on the base portion 111B may be equal to or less than 0.25 mm². Accordingly, the contrast of the display portion 110B may be enhanced, thereby improving its visibility.

In one embodiment, the projection portion 112B may be recessed with respect to the non-display portion 120B. For example, the projection portion 112B may be recessed by 0.2 mm or more and 0.5 mm or less. Accordingly, the durability of the sidewall 100B may be secured and contamination of the display portion 110B may be prevented.

A plurality of projection portions 112B may be provided, and they may be configured to be congruent with each other. Accordingly, the projection portions 112B may form a repeating pattern, improving the visibility of the display portion 110B.

The plurality of projection portions 112B may be alternately arranged with different phase differences in a radial direction D_R or in a circumferential direction D_θ. Accordingly, the aesthetics of the display portion 110B may be diversified.

In one embodiment, two adjacent projection portions 112B may have a phase difference of 90°, thereby emphasizing regularity and improving visibility of the display portion 110B.

Furthermore, the plurality of projection portions 112B may be arranged inclined in both a radial direction D_R and a circumferential direction D_θ. Even in this case, the projection portions may be arranged alternately with different phase differences. Accordingly, the display portion 110B may achieve design freedom and aesthetic diversity.

Each projection portion 112B may comprise a pair of protrusions 112B_1 protruding outward and a pair of recesses 112B_2 recessed inward. The directions “outward” and “inward” may refer to directions perpendicular to the axial direction D_AX or equivalent directions.

One of the pair of protrusions 112B_1 provided on one projection portion 112B may be insertable into one of the pair of recesses 112B_2 provided on an adjacent projection portion 112B. Accordingly, the base portion 111B and the projection portion 112B can densely and regularly fill the display portion 110B, improving its visibility.

Furthermore, the projection portion 112B may further comprise four right-angle portions 112B_3 that connect the pair of protrusions 112B_1 and the pair of recesses 112B_2 at right angles. The right-angle portions 112B_3 also contribute to densely and regularly filling the display portion 110B, improving its visibility.

Meanwhile, as illustrated in FIG. 7, the base portion 111B may be provided as a pair for each projection portion 112B, disposed on both sides of the projection portion 112B, and each may be concave with respect to the projection portion 112B. The three-dimensional features of the display portion 110B contribute to enhancing its visibility.

What is claimed is:

1. A tire comprising:
a sidewall including:
a display portion on a surface thereof where characters or graphics are displayed; and
a non-display portion on the surface excluding the display portion;
wherein the display portion comprises:
a base portion recessed with respect to the non-display portion; and
a projection portion provided in a closed-loop shape on the base portion.

2. The tire according to claim 1, wherein the projection portion is recessed with respect to the non-display portion.

3. The tire according to claim 1, wherein the projection portion comprises a plurality of projection portions, and
the plurality of projection portions are configured to be congruent with each other.

4. The tire according to claim 3, wherein the plurality of projection portions are alternately arranged with different phase differences.

5. The tire according to claim 4, wherein two adjacent projection portions have a phase difference of 90°.

6. The tire according to claim 4, wherein each of the plurality of projection portions includes:
a pair of protrusions formed to protrude outward; and
a pair of recesses formed to be indented inward.

7. The tire according to claim 6, wherein one of the pair of protrusions provided on one projection portion is configured to be insertable into one of the pair of recesses provided on an adjacent projection portion.

8. The tire according to claim 6, wherein each of the pair of protrusions has an obtuse angle facing each other, and
each of the pair of recesses has a reentrant angle facing each other.

9. The tire according to claim 8, wherein a sum of the obtuse angle and the reentrant angle is 360°.

10. The tire according to claim 8, wherein the projection portion further includes four right-angle portions connecting the pair of protrusions and the pair of recesses at right angles.

11. The tire according to claim 6, wherein the base portion is provided as a pair for each projection portion, disposed on both sides of the projection portion, and each is concave with respect to the projection portion.

12. The tire according to claim 1, wherein the plurality of projection portions are arranged inclined in both a radial direction and a circumferential direction.
